(19) United States
(12) Patent Application Publication
(10) Pub. No.: US 2002/0112186 A1
(43) Pub. Date: Aug. 15, 2002

(54) Authentication and authorization for access to remote production devices

(76) Inventors: Tobias Ford, Annapolis, MD (US); Robert Schwendinger, Chantilly, VA (US); David Goldschlag, Silver Spring, MD (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/950,725

(22) Filed: Sep. 12, 2001

Related U.S. Application Data
(60) Provisional application No. 60/269,018, filed on Feb. 15, 2001.

(51) Int. Cl. H04L 9/32

(52) U.S. Cl. 713/201

(57) ABSTRACT

A computer network security arrangement and method are disclosed which provides in a distributed complex computer network an authentication and authorization access for limiting access to network devices. The different levels of authentication involve the login/password process; comparison against access control lists; and mandatory program protocol control. Included are audit trails for authenticated calls and denied access calls.

### CROSS-REFERENCE(S) TO RELATED APPLICATION(S)

This application claims the benefit of U.S. Provisional Application Serial No. 60/269,018 filed on Feb. 15, 2001.

### RELATED APPLICATION

This application is related to the following co-pending application, the disclosures of which are incorporated into this specification by reference.

U.S. patent application Ser. No. 09/______ , entitled METHOD AND APPARATUS FOR AUTHORIZING AND REPORTING CHANGES TO DEVICE CONFIGURATIONS.(USi 3)

### FIELD OF THE INVENTION

The present invention relates to security in computer networks. More specifically, it relates to systems and methods for providing remote access which limits and controls availability to devices.

### BACKGROUND

The problems of unauthorized access to devices, such as servers, is a major concern of those involved in communications through inter-related computer systems, either in a communication network or through simply a plurality of terminals which are connected to a central host computer. One technique for dealing with this problem is to design software that can convincingly demonstrate that it is secured. That is, to design software that can be convincingly demonstrated to prevent access by a user to certain unauthorized levels of information and to allow access to certain authorized levels of information. One concern with this approach is that such software typically requires precise design of system functions and structures so that the resulting software is secure against state-of-the-art threats. To add such security to existing software, the architecture of the existing software would have to be significantly redesigned.

Systems exist which provide security via a password system in a communication line of a computer. Typically, this type of system requires the user to insert a password or some other form of identification as a user is logging onto a computer system. Usually the password is forwarded to a user interface, such as a communication modem, or a computer interface, which is typically a relatively intelligent interface device. The device looks up the password according to the user's name and/or separate login identity. If there is a correspondence, the communication channel to the computer is permitted.

In distributed computer networks with topologies that allow remote access from gateways or “login servers,” the provision of controlled access to multiple devices is problematic. In known access methods, authentication (for example, entry of a username and password) can either provide a user access to all devices or authentication must be carried out each time a user requires access to a particular device. Providing users access to all devices is generally an unacceptable security risk, and requiring separate authentication processing for every device is inefficient and unsuitable for users requiring access to many devices.

### SUMMARY OF THE INVENTION

Systems operating according to the principles of the invention provide access to multiple devices through layers of authentication and authorization login servers or gateways which provide the access mechanism to the multiple devices. The login server or gateway has unlimited access to the multiple devices. Each user requiring access to a device enters credentials, such as the customary username and password. The login server checks the credentials, such as via a directory of authentication credentials. Once the user credentials are authenticated, the user may request access to a particular device. Before providing the user accesses to the requested device, the login server determines whether the user is authorized to access the device via a list of associations maintained in an Access Control List (ACL). The ACL constrains the types of devices the user can access. When the user is authorized to access the requested device, the login server issues the appropriate command and the user is granted access to the requested device. If the user is unauthorized, access is denied and the login server may optionally record, or report the user's attempted access. Centrally, each login and access attempt can be audited and all actions can be recorded on event logs for later retrieval.

Once access is granted to a device a user can address the internal configuration program and change it. However, a third screen is enabled using a mandatory program profile to screen the proposed change and reject program changes which do no match stored allowed configurations within the program profile.

In one exemplary embodiment, the login or gateway server maintains unique accounts for each user. The user accounts contains the commands that the gateway server will issue for the user. A mapping of each user to authorized devices is maintained in the ACL. The gateway server monitors changes to the ACL via a collector agent. When the collector agent recognizes a change to the ACL, a corresponding change is made to the user's account; that is, commands are added are deleted for the user. In this manner, user rights can be changed systematically through updates to the ACL.

### BRIEF DESCRIPTION OF THE DRAWING

The present invention will now be described with reference to the attached figures in which:

FIG. 1 is a schematic diagram of a distributed computer network according to the principles of the invention; and

FIG. 2 is a flow chart of a connection through the computer network accessing eventually a production server through multi-levels of authentication protocols.

### DETAILED DESCRIPTION

Computers are capable of being organized into networks to share information and hardware resources, and to grant or deny access within the network to server devices which usually provide specific services or functions. Network topology refers to the physical layout of the network, especially the locations of the computers, which in the case of the present invention involves accesses from remote sites.

Networks may be organized into various known arrangements such as the bus, the star, the ring and the mesh. The bus topology is basic and relatively simple. Usually, the topology of a given network involves some combination of those known topologies, and in the case of the instant invention, most topologies and combinations thereof can be used advantageously with the instant invention.

Before discussing the invention in greater detail, a brief discussion about network operating systems (NOS) is in order. The NOS provides network functionality, network protocol support, file and print sharing, and all other network-centric activities. Generally, the computer world is divided into NOSes of two types. Some NOSes are for client/server networking and the remaining NOSes are designated to serve requests from the network as well as those generated by a local work server. The latter NOSes are sometimes referred to as peer NOSes. In a complex network there will be many NOSes dependent on the tasks to be performed, and, occasionally, NOSes will appear to perform both functions on a time shared basis. However, for the discussion of this invention, it is assumed that peer NOSes function with individual workstations, and the production servers, which have restricted access and thus require authenticated protocol access, are operated by non-peer NOSes. This should not be understood to be a restriction in terms of the instant invention, but only a vehicle to assist in the discussion of this invention.

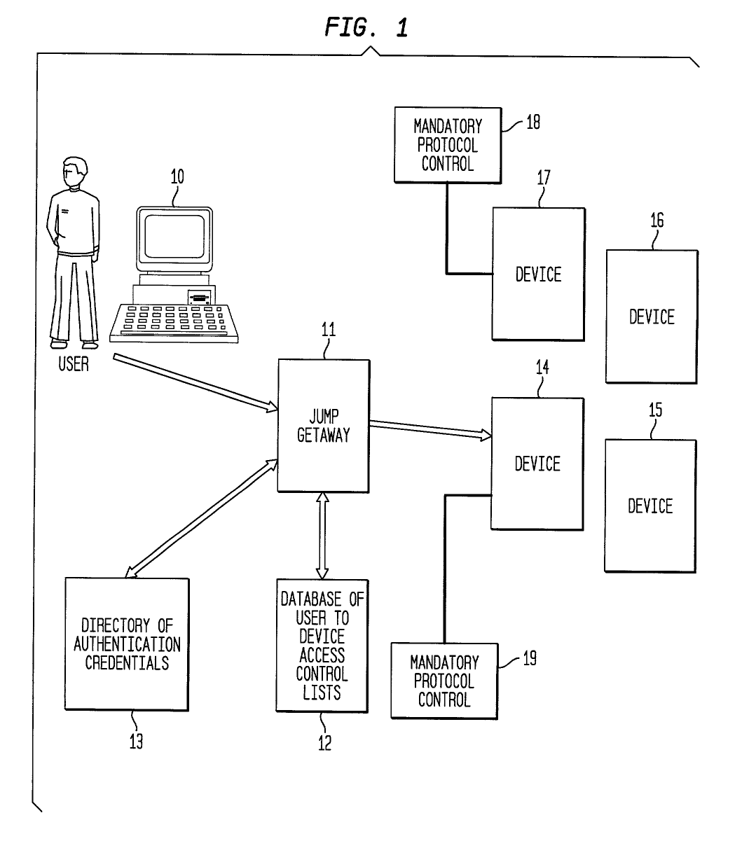

Referring now to FIG. 1, there is shown a block diagram representation of a computer network having a local computer 10, and an access gateway (login sever) or Jump Gateway 11 for providing access to multiple devices 14 to 17. The gateway 11 has unlimited access to the devices 14 to 17, and grants access to a user 09 operating the local computer 10 according to an authentication and authorization process to be described hereafter. In this exemplary embodiment, the gateway 11 also has access to a directory of authentication credentials 13 and a database 12 of user to device access control lists (ACLs). The directory of authentication credentials 13 can include, for example, usernames and passwords for permitting the user 09 to login to the gateway 11. The ACLs can include, for example, a mapping or association of authenticated users to devices selected from the available devices 14 to 17. The system also can be secured by mandatory protocol profiles control 18 or 19 that only allow certain programs to be executed in devices 14 and 17.

In the embodiment of FIG. 1, access to devices 14 to 17 is granted when a user is authenticated and when access is authorized. A user 09 can login to the network by presenting credentials to the login server 11. The login server checks the credentials in the directory 13 of authentication credentials. The user can then request access to the devices 14 to 17. The login or gateway server 11 maintains unique accounts for each user. The user accounts contains the commands that the gateway server 11 will issue for the user. The commands in the account are derived from the user-device associations in the ACLs. When a user requests access to a device, access can only be granted if the gateway can issue the appropriate command from the account. The gateway server 11 monitors changes to the ACLs 12 via, for example, a collector agent (not shown). When the collector agent recognizes a change to the ACL, a corresponding change is made to the user's account; that is, commands are added or deleted for the user. In this manner, user rights can be changed systematically through updates to the ACL.

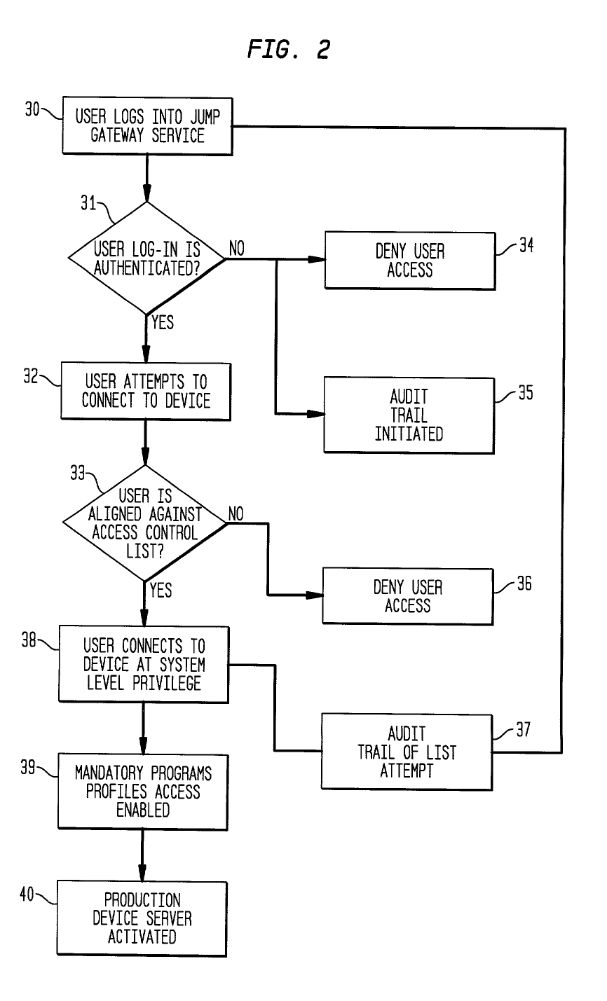

Referring now to FIG. 2, a flow chart illustrating processing according to the principles of the invention is shown. In the first step 30, the user logs into the gateway server. In step 31, the user is authenticated at the first level of access control. Authentication can be carried out by checking credentials such as username and password. If the user's credentials are valid, the user is permitted access to the gateway server, and process flow then continues in process step 32. Otherwise, access is denied in a process step 34. In step 32, the user identifies the production device for which access is desired, and in step 33 the user's authorization to access the requested device is checked. As explained with reference to FIG. 1, authorization can be carried out by constraining the user's access to selected devices based upon a user-device mapping or association. If the user is privileged to access the device, access is granted, as at 38. To complete access, mandatory protocols are enabled and the device is actuated, as at 39 and 40. If the user is not privileged to access the requested device, access is denied, as at 36. Optionally, audit trails can follow the denial of access, as at 35 and 37. Audit trails can log request and denial events.

At step 39 the user attempts to re-configure the program but the type and scope of change is restricted to those stored in the mandatory program profiles. Thus, step 39 provides a finally screen for authorized users who have been authenticated. If the re-configure does not match one of the profiles the system does not advance to step 40.

In an exemplary embodiment, the gateway or login servers are Solaris 2.7 systems. Authentication is performed on these servers via a centrally located authentication directory sever 13. Each user 10 who requires access to the login server 11 will have a unique credential (username and password) on the login server 11. The user 10 obtains access to the login server by:

(1) Figurative Access and Authorization by a member of the group of managers (resource manager, crisis manager, delivery manager). For example, given a request for access by a user lacking direct connectivity, a manager accesses the login server to see if there was literal access to the requesting user. The manager then gives access via for example, a password.

(2) Literal Access and Authorization by the “login server manager” who configures the credentials in server 11 or 13. The “login server manager” is an ongoing function of the “password/login server manager” and administrators.

Authorization on the login server 11 for access to external Devices 14-17 is performed by software installed on the login server 11 called Sudo. As will be appreciated, Sudo software controls who can access which devices 14-17 and provides the tools to access the device. Sudo software allows a permitted user to execute a command, specifically a login command such as ssh or RADware. Sudo software determines who is an authorized user by consulting the file/etc/sudoers, the administration of which is described below. By giving the Sudo Software the −v flag, a user can update the time stamp without running a command. The password prompt itself will also time out if the password is not entered with N minutes (again, this is defined at installation time and defaults to 5 minutes). If an unauthorized user executed a Sudo command, mail will be sent from the user 10 to the local authorities (defined at installation time). Sudo software is designed to log via the 4.3 BSD syslog (3) facility available on all supported UNIX platforms. All syslog information is processed through the monitoring system. The monitoring system takes all Sudo software events and redirects them to the appropriate person who can act on the problem. Sudo is GPL software.

The credentials and access control lists used for the authentication and authorization process for logging into servers is managed by a central OSS system, such as Solaris. The central OSS system stores the information required to configure the authorization and links that information to other sources of information, such as the internal MIS domain authentication architecture, to provide data normalization.

Users can access production servers remotely through a Jump Gateway 11 (only one is shown). Jump Gateway 11 is, for example, a Microsoft Windows 2000 server running Terminal Server services within the network (domain). Users login into the Jump Gateway 11 using their unique corporate user ID, then call the GEMC (Gateway Employee Master Control) who will connect the logged-in user to the production server that they are authorized to access. Jump Gateway 11 audits all logons and actions that occur. The system is also secured by mandatory protocol profiles control 18 or 19 that only allow certain programs to be executed in devices 14 and 17. For example, most production servers can be accessed from the Jump Gateway 11 by PC Anywhere (Windows NT servers) and Terminal Server Client (Windows 2000 servers). PCAnywhere and Terminal Server Client usage can be tracked through the event logs within the network operating system.

Jump Gateway 11 is used for authentication for connections to client servers, such as devices 14 to 17. Users requiring access to production servers, devices 14-17, submit an Internal Authentication Request form. This form is sent to the Account Administrator for the GEMC. This must be completed and signed by the user and, for example, a manager. The GEMC is also notified of user terminations and departures via e-mails that are generated from the human resources application. The GEMC Account Administrator then deletes the user identity in Gateway 11 and in credentials 13 which removes access. Different types of devices 14-17 have different access mechanisms, which will be discussed next.

In general, to access customer production firewalls or UNIX or NT servers, which are part of devices 14-17, users must first access Jump Gateway 11. Gateway 11 authenticates users and provides a centrally administered system. If the user is authorized to access the customer server, the Jump Gateway 11 servers will either automatically complete the connection, or a GEMC employee will manually complete the connection. This process is discussed in greater detail in the paragraphs that follow for UNIX and Windows NT/Windows 2000 devices.

UNIX Devices

Although only one Jump Gateway 11 is shown, in reality in complex networks having multiple UNIX Devices, separate UNIX Gateway 11 servers control access to designated UNIX devices, such as for example, devices 14-17. In production environments where UNIX Devices are frequently used, one may also encounter NOKIA Firewalls with UNIX servers, WSD Pro servers, and UNIX-based DNS servers. In any event, the approach is the same. Users first authenticate in Jump Gateway 11 using a unique name and password. The primary domain controller maintained by the GEMC then authenticates them. Once authenticated to Jump Gateway 11, authorization for access to a specific customer production server is performed by UNIX compatible Sudo software program installed on the loggin server in Gateway 11. Sudo programming is used to control who can access which devices as well as which commands can be used. Sudo software allows an authorized user to execute a command, specifically a login command. Permissions are pre-defined during the user account set up process. The access control lists and passwords used in the authentication and authorization process for logging into servers is contained in a central US Oasis (OSS) Oracle database. This database is updated and controlled via a web-based login server manager that is accessible only by a limited number of people. All commands executed via Sudo software are logged. The logged information is processed through the monitoring system and is sent to NetCool®, which collects multipurpose events, alerts and messages and stores them in a database. The information can then be sorted and viewed in various formats. NetCool® is available from Micromuse. Each access attempt to the Jump Gateway 11 is also logged. These logs provide accountability for users accessing customer servers.

Windows and Windows NT Devices

For systems including Windows and Windows NT Devices, users first establish a connection to Jump Gateway 11 using a unique username and password maintained by the GEMC. The sessions are established using PCAnywhere, Citrix, or Terminal Server. Once the session with the Jump Gateway 11 is established, the employee must call the GEMC and ask to be connected to a specific customer server, e.g. 14-17. The GEMC queries the OSS database in Lists 12 and determines if the user is authorized to access the desired customer server. All inquiries through the interface to the OSS database (not shown in detail) by the GEMC are logged. The GEMC then establishes a second session with the customer server. Once the GEMC authenticates to the customer server, the user takes over the session. The user does not see the customer server password during this process. Every 30 days, a script is run to change all customer server passwords, both within the OSS database and on the production server. Should a connection not be able to be established to a server, the GEMC has the option to give the user the password depending upon the urgency of the situation. If this is done, then a temporary password is given to the user and it is changed back by the GEMC after the work is complete. Access to the passwords and connections to the Jump Gateway 11 servers are logged.

The present invention may, of course, be carried out in other specific ways than those set forth herein without departing from the spirit and the central characteristics of the invention. The present embodiments are, therefore, to be considered in all respects as illustrative and not restrictive, and all changes coming within the meaning and the equivalency range of the appended claims are intended to be embraced herein.

What is claimed is:

1. In a network having multiple devices, a method for granting device access to a prospective user, the method comprising the steps of:
maintaining a user to device association;
receiving a request for access to the device; and
granting the user access to at least one of the devices according to the association.

2. The method of claim 2 comprising the further steps of:
maintaining credentials associated with the user;
receiving user credential inputs;
comparing the user credential inputs to the credentials associated with the user; and
checking the user to device association when the user credential inputs and credentials associated with the user match.

3. The method of claim 2 comprising the further step of permitting access to the device with mandatory program profiles enabled based upon the association.

4. The method of claim 1, further comprising the step of recording particulars of an attempted access.

5. The method of claim 1, further comprising the step of denying access when the prospective user is unauthorized to access the device.

6. The method of claim 1, further comprising the step of reporting the denial of access to a device.

7. The method of claim 3 further including the step of comparing a proposed re-configure program against stored mandatory profile programs.

8. The method of claim 7 further including a production device activation when the profile and re-configure program matches.

9. A method for granting selected access to devices in a network via a login server, the method comprising the steps of:
maintaining a plurality of commands associated with users, the commands when executed causing the login server to grant access to corresponding devices;
in response to a login request, granting access to the login server based upon user credentials; and
in response to a request for access to ones of the devices, executing the commands associated with the user.

10. The method set forth in claim 9 further including a mandatory program file associated with each device for screening user re-configure programs.

11. The method set forth in claim 10 wherein a screen match between a re-configure program and a mandatory program file is made each time an authorized user is given access.

12. The method set forth in claim 11 where a screen match verifies an authorized program re-configuration has been entered to activate the production device working in a re-configured mode.

13. The method set forth in claim 11 wherein a failure to verify a re-configuration request results in a de-activation of a production server.

14. A network comprising:
a plurality of devices;
at least one port for providing remote access to the devices;
a login server responsive to requests from the at least one port for access to the network and operable to receive credentials for access to the network;
a storage medium for storing credentials associated with users and a plurality of user to device associations;
the login server operable to grant access to the network to users having credentials corresponding to the credentials associated with users and to execute commands for granting access to the devices according to the user-to-device associations.

15. The network of claim 14 wherein the login server includes a collector agent for monitoring the changes to the user to device associations.

16. The network of claim 14 comprising in addition
a program re-configuration screen including a file of authorized program appropriate to each device and
means for activating the screen on each authorized access to said device.

17. The network of claim 16 wherein detection by the program screen indicates an unauthorized program has been entered to de-activate the device.

18. The network of claim 16 wherein detection by the program screen indicates an authorized program was entered for activating the device.

19. A system for providing secured access to programmable production device comprising
a first screen for authorized users which requires the entry of recognized names and passwords,
a second screen which utilizes authorized names and passwords to grant access exclusively to certain production devices based upon a predetermined association list of names, passwords and devices, and
a third screen which analyzes re-configuration program requests and compares such requests against an authorized list of programs for the accessed device.

20. The system of claim 19 which further includes means for activating the particular production device only if each of the three screens are properly satisfied.
